(19) United States
(12) Patent Application Publication
(10) Pub. No.: US 2006/0028678 A1
(43) Pub. Date: Feb. 9, 2006

(54) Image processing apparatus and its control method

(75) Inventors: Akira Negishi, Kawasaki-shi (JP); Yukihiko Shimizu, Urayasu-shi (JP); Noriyuki Kobayashi, Kawasaki-shi (JP); Takeshi Namikata, Yokohama-shi (JP); Atsushi Matsumoto, Shinagawa-ku (JP); Tomohiro Akiba, Setagaya-ku (JP); Takeshi Suwabe, Edogawa-ku (JP); Naohiro Isshiki, Kawasaki-shi (JP); Hidehiko Yokoyama, Machida-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/197,511

(22) Filed: Aug. 5, 2005

(30) Foreign Application Priority Data
Aug. 6, 2004 (JP) 2004-231438

(51) Int. Cl. G06F 3/12

(52) U.S. Cl. 358/1.15

(57) ABSTRACT

When data of a print job are stored on another device or a file server, data transfer is required to obtain image data, and the start of a print process and a preview process take time compared to a print job whose data is stored in a local storage device. Hence, a print job is started, and it is checked if data for all pages of the print job are locally held. If data for all pages of the print job are locally held, a print process is continued; otherwise, data for remaining pages are obtained and undergo the print process parallel to the print process for a first part.

### FIELD OF THE INVENTION

The present invention relates to an image processing apparatus and its control method and, more particularly, to a print process and preview process of an image processing apparatus connected to a network.

### BACKGROUND OF THE INVENTION

In recent years, as hard disks have larger storage sizes and lower prices, a printer, copying machine having a printer function, multi-functional peripheral equipment (MFP), and the like comprise large-capacity hard disks. Such hard disk stores images scanned by a scanner, images obtained by rendering page description language (PDL) data, facsimile reception documents, and the like, and stored images, documents, and the like can be repetitively printed.

In addition, along with the popularization and improvement of the communication speed of a network, as described in Japanese Patent Laid-Open No. 11-224268, a distributed storage in which devices connected to the network store and share distributed image files has been proposed.

However, when an entity of image data is stored in another device or a file serer, data transfer is required to obtain image data, and the start of a print process and a preview process take time compared to a job whose entity of image data is stored in a local storage device.

### SUMMARY OF THE INVENTION

The first aspect of the present invention discloses a technique for, when data of a print job is held in a memory, a print process or preview process is executed based on the print job, and partial data of the print job is held in the memory, obtaining the remaining data from another image processing apparatus via a computer network and supplying that data to the print process or preview process.

According to the present invention, even when data of a print job is stored in another device, the start of the print process or the preview process can be made in good time.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a view for explaining an overview of a distributed storage;

FIG. 2 is a block diagram showing the arrangement of an MFP;

FIG. 3 is a schematic view showing a reader and printer;

FIG. 4 is a block diagram showing the arrangement of a core unit;

FIG. 5 is a view for explaining job control;

FIG. 6 is a view for explaining sessions as combinations of image input jobs and image output jobs;

FIGS. 7A to 7C are flowcharts for explaining the control sequence of a PDL print session 501;

FIG. 8 shows a session management table;

FIG. 9 shows an outer appearance of a control panel;

FIG. 10 shows a FAT prepared in a storage unit or core unit;

FIG. 11 conceptually shows the use state of a hard disk managed by the FAT;

FIGS. 12A and 12B are flowcharts showing the control sequence executed by a CPU in a disk full state;

FIGS. 13 and 14 show examples of selection dialogs;

FIG. 15 shows an example of the structure of data of a print job stored in a hard disk;

FIG. 16 shows an example of the data structure when a distributed storage by partial redundant holding is applied;

FIG. 17 is a flowchart showing the processing upon executing a print job;

FIG. 18 shows a session management table;

FIG. 19 shows a job management table associated with an image input job; and

FIG. 20 shows a job management table associated with an image output job.

### DESCRIPTION OF THE PREFERRED EMBODIMENTS

Preferred embodiments of the present invention will be described in detail hereinafter with reference to the accompanying drawings.

[Overview]

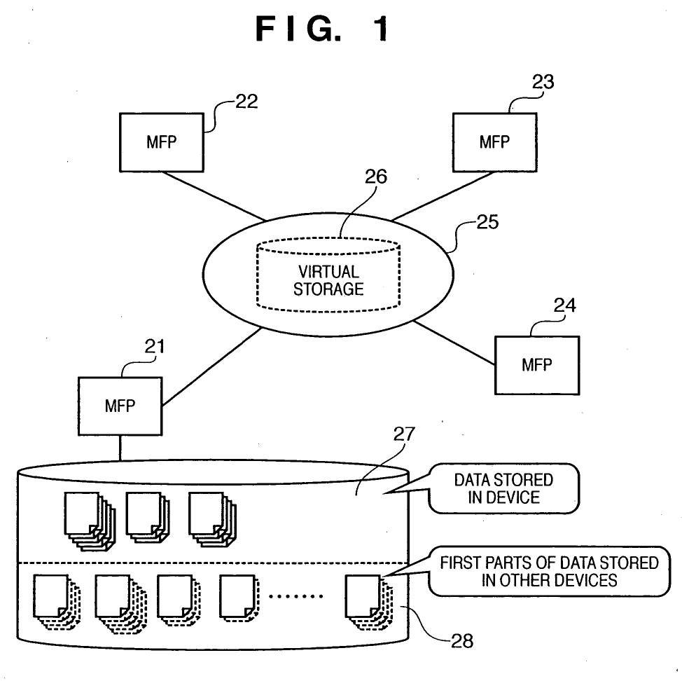

FIG. 1 is a view for explaining an overview of a distributed storage of this embodiment.

A plurality of MFPs 21, 22, 23, and 24 are connected to a network 25. These MFPs have hard disks as storage devices, which are shared and cross-referenced among the MFPs connected to the network. That is, the MFPs share a virtual storage 26.

For example, the hard disk of the MFP 21 has a storage area 28 used to redundantly hold only a first part (e.g., the first page or the like) of data stored in another device, in addition to a storage area 27 of data stored in that device. When the MFP 21 executes a print process, it refers to the storage contents of the hard disk of itself. If a print job of data stored in the storage area 27 is issued, the MFP 21 reads out that data, and executes the print job. On the other hand, if a print job of data stored in the storage area 28 is issued, the MFP 21 reads out that data (only the first part), sends a request of the remaining data to another MFP via the network 25, receives the data, and executes the print job. Of course, other MFPs have the same scheme.

Note that the technique of such distributed storage is called a “distributed storage by partial redundant holding”.

[MFP]

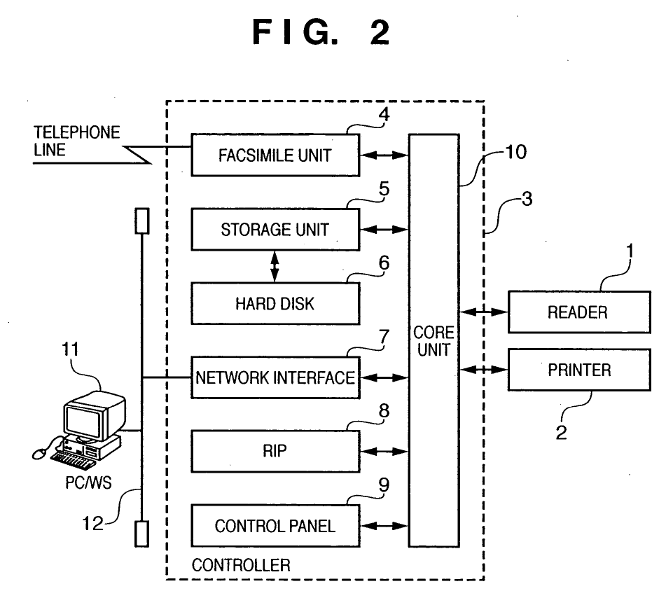

FIG. 2 is a block diagram showing the arrangement of an MFP.

A reader 1 reads light reflected by a document image using a CCD image sensor or the like, and outputs image data corresponding to the document image to a controller 3. A printer 2 is, e.g., a laser beam printer, which prints an image according to image data input from the controller 3 on a print sheet. The controller 3 includes a facsimile unit 4, storage unit 5, network interface 7, Raster Image Processor (RIP) 8, control panel 9, core unit 10, and the like.

The facsimile unit 4 decodes facsimile data received via a telephone line, and transmits image data obtained by decoding to the core unit 10. Also, the facsimile unit 4 encodes image data received from the core unit 10, and transmits facsimile data obtained by encoding to a designated destination via the telephone line. Note that image data to be exchanged can be saved in a hard disk 6 by the storage unit 5.

The storage unit 5 has the hard disk 6. The storage unit 5 compresses image data received from the core unit 10, and stores the compressed image data in the hard disk 6 together with an ID number required to retrieve that image data. The storage unit 5 extracts compressed image data stored in the hard disk 6 on the basis of a code such as an ID number or the like received from the core unit 10, decompresses the extracted compressed image data, and transmits the decompressed image data to the core unit 10. Note that the hard disk 6 has a storage capacity of, e.g., 200 GB, and can store about hundred thousand pages of A4-size images although it depends on the image contents. Furthermore, the storage unit 5 detects the presence/absence of connection and troubles of the hard disk 6 by making a command/response, read/write and collation of predetermined data via a hard disk interface.

The network interface 7 is connected to a local area network (LAN) 12 to provide an interface between the core unit 10 and a personal computer (PC) or workstation (WS) 11 connected to the LAN 12.

The RIP 8 renders PDL data received from the PC/WS 11 to image data that can be printed by the printer 2.

The control panel 9 is a user interface of the MFP, which comprises a touch panel display and hardware keys. The control panel 9 receives operation instructions and setting instructions to the MFP and transmits them to the core unit 10. Also, the control panel 9 displays the operation status and the like of the MFP received from the core unit 10.

As will be described in detail later, the core unit 10 controls the reader 1, printer 2, facsimile unit 4, storage unit 5, network interface 7, RIP 8, and control panel 9 to control the data flow among these components.

[Reader and Printer]

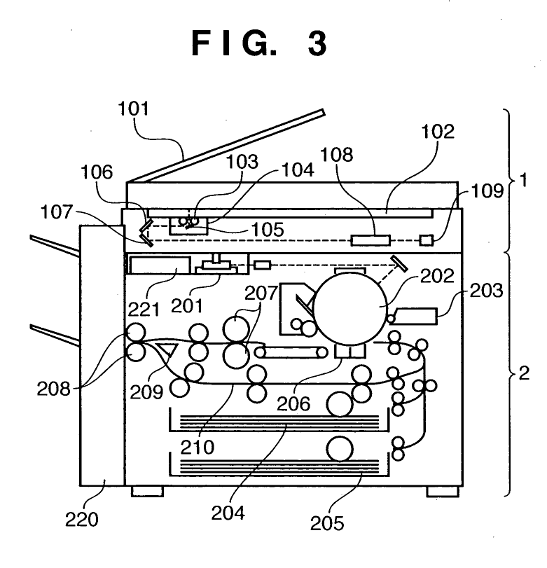

FIG. 3 is a schematic view showing the reader 1 and printer 2.

A document feeder 101 of the reader 1 feeds a plurality of documents set by the user on a predetermined tray one by one in turn from the first page to a platen glass 102. Upon completion of reading of a document image, the document feeder 101 feeds a document on the platen glass 102 to a predetermined exhaust tray.

When a document is fed onto the platen glass 102, the reader 1 turns on a lamp 103 and begins to move a scanner unit 104 so as to optically scan the document. Light reflected by the document is guided to a CCD image sensor 109 via mirrors 105, 106, and 107, and a lens 108, The CCD image sensor 109 outputs an image signal obtained by photoelectrically converting the reflected light from the document. This image signal undergoes predetermined image processes such as A/D conversion, shading correction, color space conversion, and the like, and the processed image signal is then transferred to the core unit 10 of the controller 3.

A laser driver 221 of the printer 2 drives a laser emission unit 201 in accordance with image data input from the core unit 10 of the controller 3. A laser beam output from the laser emission unit 201 strikes a photosensitive drum 202 to form an electrostatic latent image on its surface. A developer 203 applies toner to this electrostatic latent image.

A print sheet fed from a cassette 204 or 205 is conveyed to a transfer unit 206 at a timing synchronized with the start of irradiation of the laser beam, and the transfer unit 206 transfers the toner image on the photosensitive drum 202 to the print sheet. The print sheet on which the toner image is transferred is conveyed to a fixing unit 207, which fixes the toner image to the print sheet by heat and pressure. The print sheet that leaves the fixing unit 207 is exhausted to a finisher 220 by exhaust rollers 208. The finisher 220 sorts print sheets by binding a plurality of pages, and applies a staple process or the like to the sorted print sheets.

When a two-sided print mode is set, a print sheet on one face of which an image has been printed is conveyed to the exhaust rollers 208, and is then guided to a re-feed convey path 210 by reverse rotation of the exhaust rollers 208 and a flapper 209. The print sheet guided to the re-feed convey path 210 is fed to the transfer unit 206 at the aforementioned timing, and an image is printed on the other face.

[Core Unit]

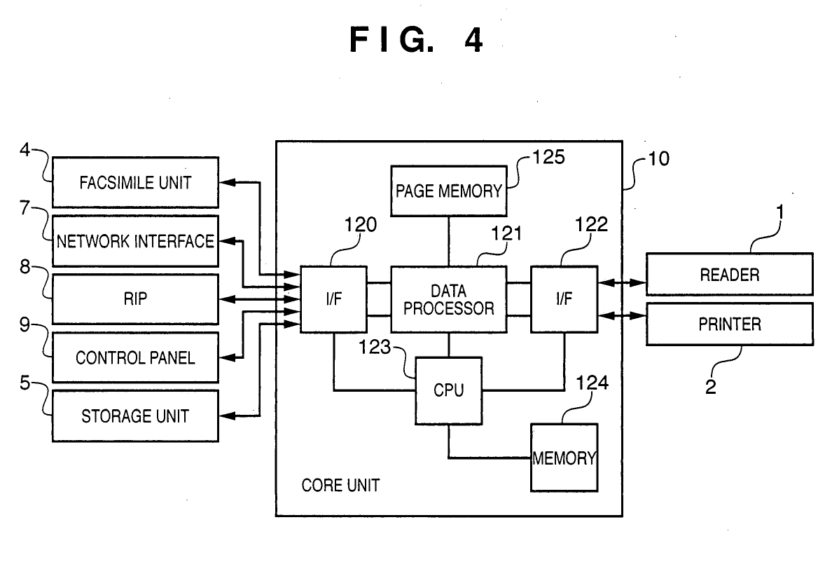

FIG. 4 is a block diagram showing the arrangement of the core unit 10.

Image data input from the reader 1 to the core unit 10 is input to a data processor 121 via an interface (I/F) 122. The data processor 121 executes image processes such as rotation, zooming, and the like of an image, and compression/decompression of image data, and has a page memory 125 which can store A4 or letter size equivalent image data for four pages. Image data transferred from the reader 1 to the data processor 121 is temporarily stored in the page memory 125, is then compressed, and is input to the storage unit 5 via an I/F 120.

Also, PDL data input to the core unit 10 via the network interface 7 is input to the data processor 121 via the I/F 120, and is input to and rendered by the RIP 8 via the I/F 120 again. The rendered image data is input to the data processor 121 via the I/F 120, and is temporarily stored in the page memory 125. After that, the image data is compressed and is input to the storage unit 5 via the I/F 120.

Image data input from the facsimile unit 4 to the core unit 10 is input to the data processor 121 via the I/F 120, and is temporarily stored in the page memory 125. After that, the image data is compressed and is input to the storage unit 5 via the I/F 120.

On the other hand, image data input from the storage unit 5 to the core unit 10 is input to the data processor 121 via the I/F 120, and is temporarily stored in the page memory 125 after it is decompressed. After that, the image data is input to the printer 2, facsimile unit 4, or network interface 7 via the I/F 120 or 122.

Of course, after image data is input to the data processor 121 and is temporarily stored in the page memory 125, that image data can be transferred to the printer 2, facsimile unit 4, or network interface 7 before the image data is transferred to the storage unit 5.

A CPU 123 controls the above components to execute an instructed operation in accordance with a control program stored in a memory 124 and an instruction input from the control panel 9 via the I/F 120. Note that the memory 124 is also used as a work area of the CPU 123.

In this manner, processing that combines functions such as reading of a document data, printing of an image, transmission/reception of an image, saving of an image, input/output of image data with the computer, and the like can be made by the core unit 10 via the data processor 121 and storage unit 5.

The arrangement for storing image data in the storage unit 5 in the MFP has been explained. Alternatively, an external server may be accessed via the network interface 7 and network 12 to store image data in that server.

[Job Control]

Job control to be executed by the CPU 123 of the core unit 10 in the controller 3 will be described below taking as an example a case wherein the hard disk 6 is normal.

Job Control Unit

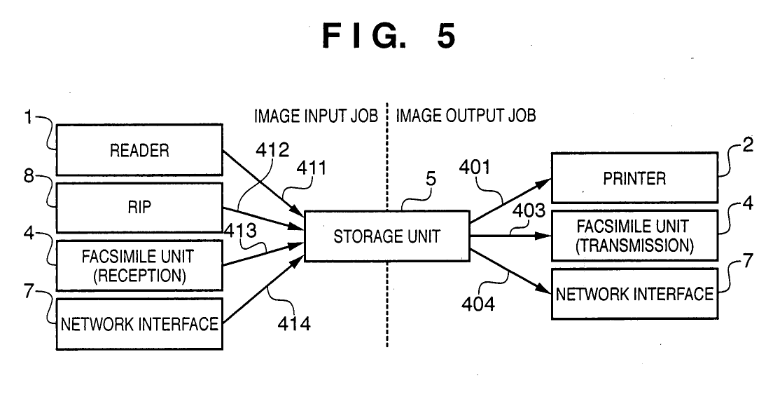

FIG. 5 is a view for explaining job control, and logically shows job control units.

The job control units are a series of input and output processes for a group of image data including a plurality of pages. Hence, jobs are roughly classified into image input jobs and image output jobs.

The image input jobs are classified into (i) an image input job 411 for sequentially storing image data read by the reader 1 in the storage unit 5, (ii) an image input job 412 for sequentially storing image data rendered by the RIP 8 in the storage unit 5, (iii) an image input job 413 for sequentially storing image data received by the facsimile unit 4 in the storage unit 5, and (iv) an image input job 414 for sequentially storing image data input from the network interface 7 in the storage unit 5.

The image output jobs are classified into (i) an image output job 401 for sequentially outputting image data read out from the storage unit 5 to the printer 2, (ii) an image output job 403 for sequentially outputting that image data to the facsimile unit 4, and (iii) an image output job 404 for sequentially outputting that image data to the network interface 7.

Session

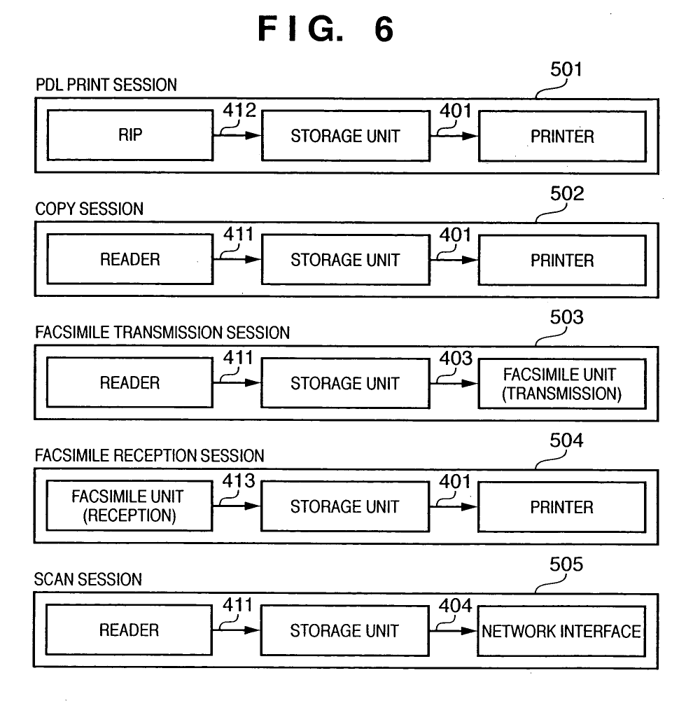

FIG. 6 is a view for explaining units as combinations of image input jobs and image output jobs (to be referred to as “sessions” hereinafter).

The sessions include (i) a PDL print session 501 as a combination of the image input job 412 and image output job 401, (ii) a copy session 502 as a combination of the image input job 411 and image output job 401, (iii) a facsimile transmission session 503 as a combination of the image input job 411 and image output job 403, (iv) a facsimile reception session 504 as a combination of the image input job 413 and image output job 401, and (v) a scan session 505 as a combination of the image input job 411 and image output job 404.

Note that the session is a control unit including one or more jobs. In addition to the sessions shown in FIG. 6, for example, the image input job 411 may be handled as one session, the image output job 401 may be handled as one session, and the image input job 411 may be combined with two or three out of the image output jobs 401, 403, and 404 and a combination of a total of three or four jobs may be handled as one session.

Session Control

A session control task and job control task executed by the CPU 123 of the core unit 10 in the controller 3 when a disk full state, in which the hard disk 6 has no free area, does not occur will be described below. Note that the CPU 123 executes multi-task processing of the session control task, image input job control task, and image output job control task. An operation executed when the disk full state (predetermined maximum storable capacity) of the hard disk 6 is reached during storage of image data in the hard disk 6 will be described later.

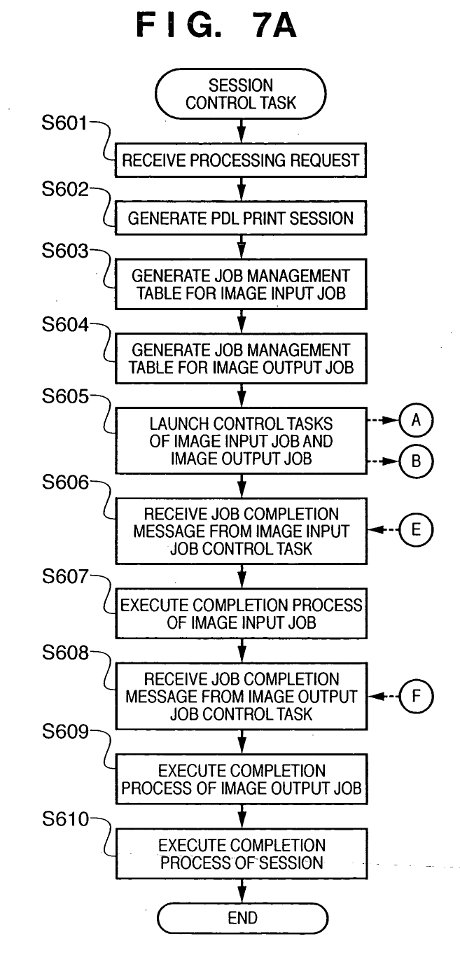

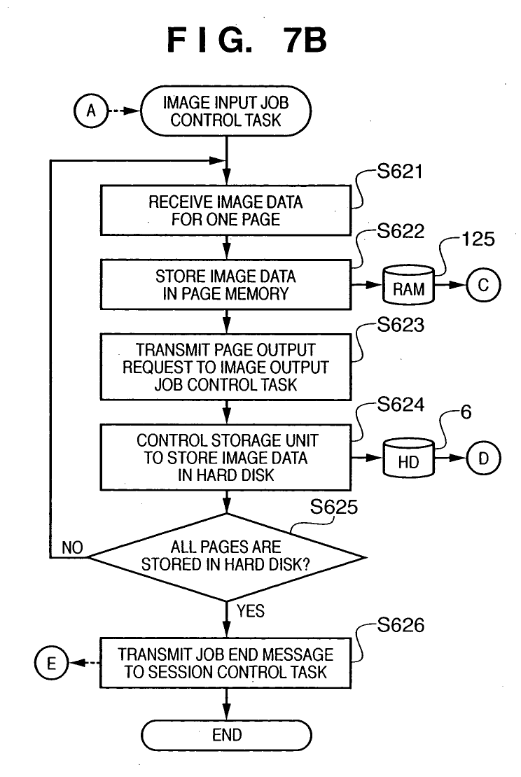

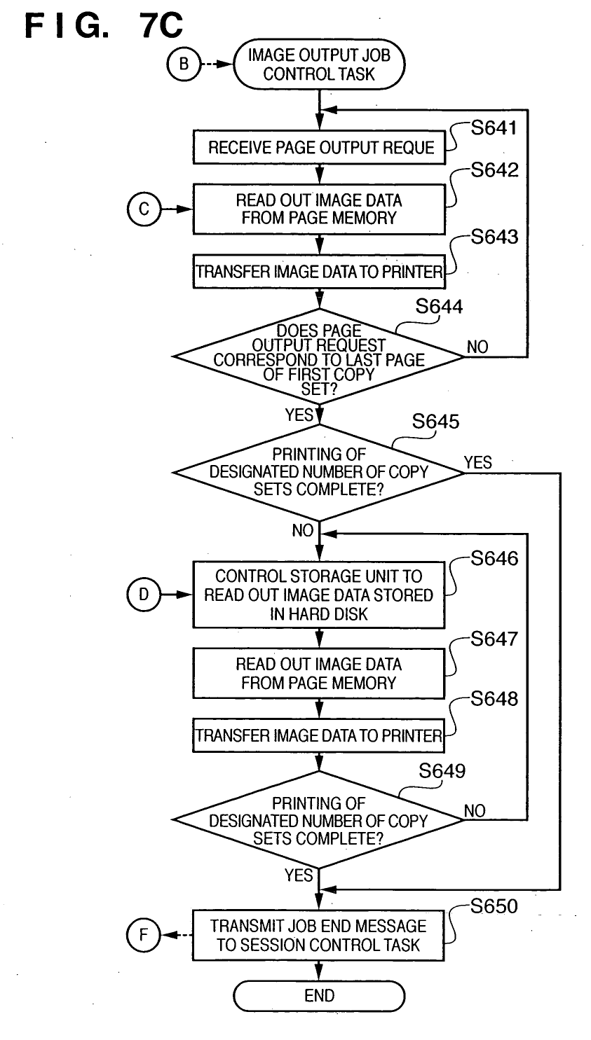

FIGS. 7A to 7C are flowcharts for explaining the control sequence of the PDL print session 501.

The user makes print settings on the PC/WS 11. The setting contents include the number of pages, the number of copy sets, a document size, a print sheet size, an enlargement/reduction ratio, one/two-sided printing, a layout, a page output order, a sort mode, and the like. Assume that the following settings are made in this case.

P1: number of pages=20

P2: number of print copy sets=10

P3: one-sided printing=yes

P4: document size=A4

P5: print sheet size=A4

P6: enlargement/reduction ratio=100%

P7: layout=OFF

P8: page output order=ascending order

P9: sorting=ON

After the print settings, when the user inputs a print instruction to the PC/WS 11, a printer driver installed in the PC/WS 11 converts document (image) data to be printed into PDL data, and transmits the PDL data including the set print setting parameters P1 to P9 to the MFP (controller 3) connected to the network 12 via a network interface card (NIC) of the PC/WS 11.

Upon reception of a print job, the controller 3 inputs the PDL data to the data processor 121. After that, the PDL data is transferred to the RIP 8, and is sequentially rasterized to image data. When the RIP 8 begins to receive the PDL data, it issues a processing request to the CPU 123 of the core unit 10. The print setting parameters P1 to P9 are transferred to the CPU 123 together with this processing request.

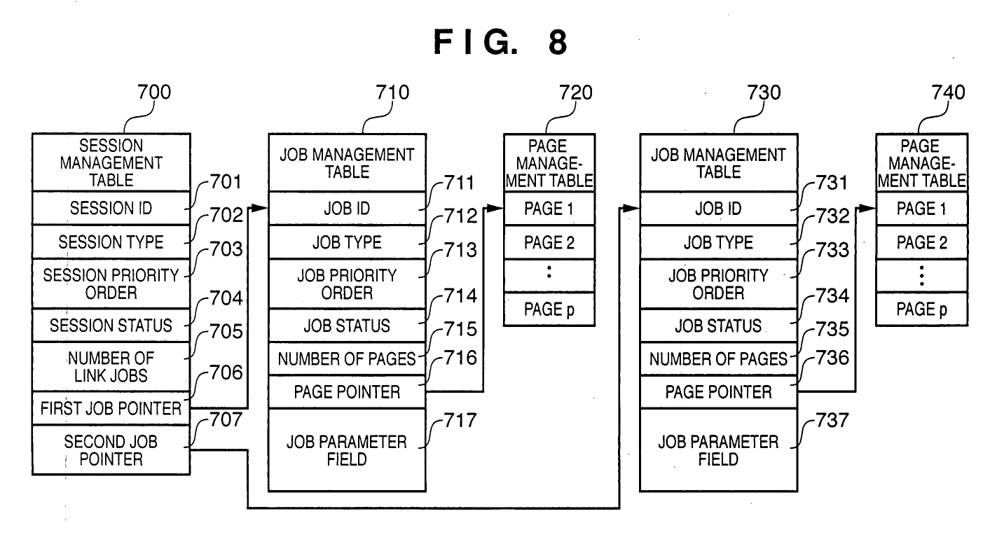

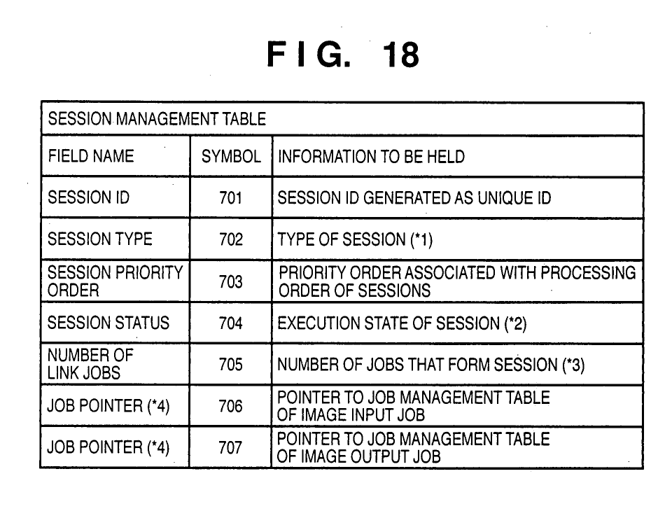

Upon reception of the processing request (S601), the CPU 123 (session control task) divides the processing request of one unit into an image input job and image output job, generates a session (PDL print session 501 in this example) corresponding to these jobs (S602), and manages the session using a session management table 700 shown in FIG. 8. The session management table 700 is generated on the memory 124, and holds various kinds of information (see FIG. 18) until the session is completed.

Note that in FIG. 18:

1: The session type is information indicating the PDL print session 501 in this example, but it may also indicate the copy session 502, facsimile transmission session 503, facsimile reception session 504, and scan session 505, as described above.

2: The job status includes an execution ready state, execution state, interrupted state, completion state, error state, and the like.

3: In this example, since the PDL print session 501 includes two jobs, i.e., the image input job 412 and image output job 401, “2” is set as the number of jobs.

4: Job pointer fields and job management tables are prepared as many as the number of jobs which form the session.

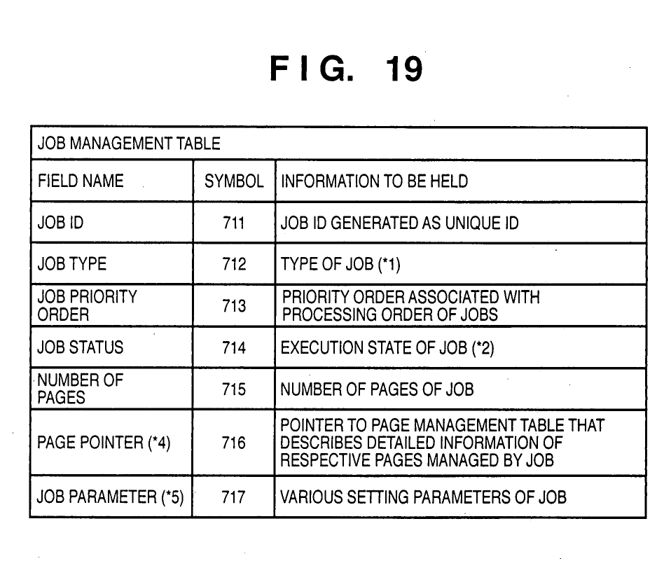

Next, the CPU 123 (session control task) generates a job management table 710 for the image input job 412 shown in FIG. 8 on the memory 124 (S603). The job management table 710 holds various kinds of information (see FIG. 19) until the image input job 412 is completed.

In FIG. 19:

1: The job type is information indicating the image input job 412 in this example.

2: The job status includes an execution ready state, execution state, interrupted state, completion state, error state, and the like.

3: In this example, since the PDL print session 501 includes two jobs, i.e., the image input job 412 and image output job 401, “2” is set as the number of jobs.

4: A page management table 720 is recorded on the hard disk 6.

5: Job parameters include the print setting parameters P1 to P9 in this example.

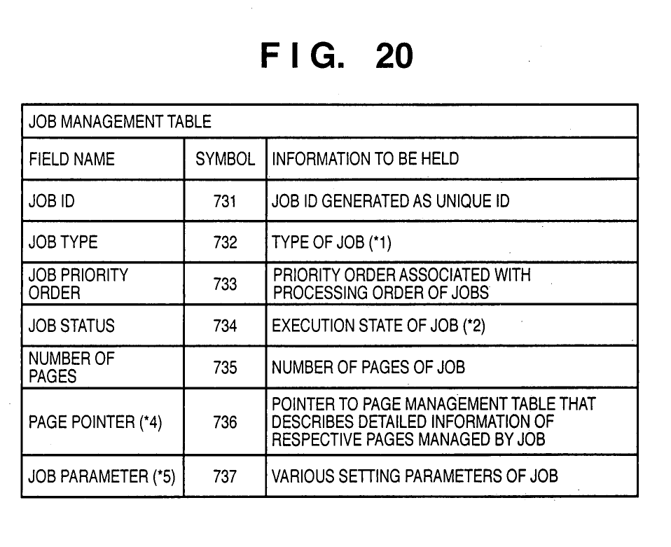

The CPU 123 (session control task) generates a job management table 730 for the image output job 401 shown in FIG. 8 on the memory 124 (S604). The job management table 730 holds various kinds of information (see FIG. 20) until the image output job 401 is completed.

In FIG. 20:

1: The job type is information indicating the image output job 401 in this example.

2: The job status includes an execution ready state, execution state, interrupted state, completion state, error state, and the like.

3: In this example, since the PDL print session 501 includes two jobs, i.e., the image input job 412 and image output job 401, “2” is set as the number of jobs.

4: The entity of a page management table 740 is the same as that of the page management table 720 which is recorded on the hard disk 6 in association with the image input job 412.

5: Job parameters include the print setting parameters P1 to P9 in this example.

After the job management tables 710 and 730 are generated, the CPU 123 (session control task) launches he control tasks of the image input job and image output job to instruct to start the image input job 412 and image output job 401 (S605).

Upon reception of a job completion message from the image input job control task (S606), the CPU 123 (session control task) executes a completion process of the image input job 412, and sets a completion state in a job status field 714 of the job management table 710 (S607).

Upon reception of a job completion message from the image output job control task (S608), the CPU 123 (session control task) executes a completion process of the image input job 401, and sets a completion state in a job status field 734 of the job management table 730 (S609). Next, the CPU 123 (session control task) executes a completion process of the session, releases memory resources by discarding the job management tables 710 and 730 and image data of respective pages managed by the page management tables 720 and 740, and also discards the session management table 700, thus ending a series of processes (S610).

If another image input job is not executed, and a new image input job can be started, the image input job control task starts the image input job 412 designated by the session control task.

The image input job control task receives image data for one page rendered by the RIP 8 (S621). That is, image data for one page is transferred from the RIP to the data processor 121 via the I/F 120. Next, the image input job control task stores the image data input to the data processor 121 in the page memory 125 (to be referred to as primary page storage hereinafter) (S622), and transmits a page output request (an output request of image data that has undergone primary page storage in the page memory 125) to the image output job control task (S623).

Upon completion of the read process of the image data of the page of interest from the page memory 125 by a process of the image output job control task to be described later, the image input job control task controls the storage unit 5 to store the image data stored in the page memory 125 in the hard disk 6 (to be referred to as secondary page storage hereinafter) (S624). After that, the image input job control task records various kinds of image attribute information (resolution, the number of pixels, and the like) in a page field 721 of the page management table 720.

Next, the image input job control task refers to the parameter P1 which is recorded in a job parameter field 717 and indicates the number of pages to check if image data of all pages are stored in the hard disk 6 (S625). If pages to be stored still remains, the flow returns to step S621.

After image data of all pages are stored in the hard disk 6, the image input job control task transmits a job completion message to the session control task (S626), thus ending the control.

On the other hand, if the printer 2 is not busy, and a new print operation can be executed, the image output job control task starts the image output job 401 designated by the session control task.

Upon reception of the page output request (S641), the image output job control task obtains the right of use of the printer 2, and then reads out image data from the page memory 125 (S642). The image output job control task transfers the readout image data to the printer 2 via the I/F 122 to control the printer 2 to print an image (S643).

The image output job control task refers to the parameter P1 which is recorded in a job parameter field 737 and indicates the number of pages to check if the page output request corresponds to the last page of the first copy set (S644). If pages to be output still remain, the flow returns to step S641. If the last page of the first copy set is output, the first copy set of the number of print copy sets set in the print copy set number parameter P2 is completed by the processes executed so far. Hence, in this stage, a staple process may be applied to printouts as needed.

The image output job control task refers to the parameter P2 which is recorded in the job parameter field 737 and indicates the number of print copy sets to check if the print process for the designated number of copy sets is complete (S645). If the print process for the designated number of copy sets is complete, the flow jumps to step S650.

If the number of printed copy sets has not reached the number of print copy sets designated by the parameter P2, the image output job control task controls the storage unit 5 to sequentially read out image data stored in the hard disk 6 for respective pages, and to transfer readout image data to the data processor 121 via the I/F 120 (S646). The data processor 121 stores input image data for one page in the page memory 125.

Next, the image output job control task obtains the right of use of the printer 2, and then reads out the image data from the page memory 125 (S647). The image output job control task then transfers the readout image data to the printer 2 via the I/F 122, and controls the printer 2 to print an image (S648).

The image output job control task refers to the parameter P1 which is recorded in the job parameter field 737 and indicates the number of pages to check if the page output request corresponds to the last page of the current n-th copy set (S649). If pages to be output still remain, the flow returns to step S646. If the last page of the current n-th copy set is output, the n-th copy set is completed by the processes executed so far. Hence, in this stage, a staple process may be applied to printouts as needed.

The image output job control task refers to the parameter P2 which is recorded in the job parameter field 737 and indicates the number of print copy sets to check if the print process for the designated number of copy sets is complete (S650). If print copy sets still remain, the flow returns to step S646.

Upon completion of the print process for the designated number of copy sets, the image output job control task transmits a job completion message to the session control task (S650), thus ending the control.

In the above example, the PDL print session 501 which renders PDL data received from the PC/WS 11 to image data and prints it out in accordance with the print settings set at the PC/WS 11 has been described. The above description can be similarly applied to the copy session 502 that prints out images read by the reader 1. The copy session 502 will be described below using FIGS. 7A to 7C.

The user makes various settings for a copy operation using the control panel 9 of the controller 3.

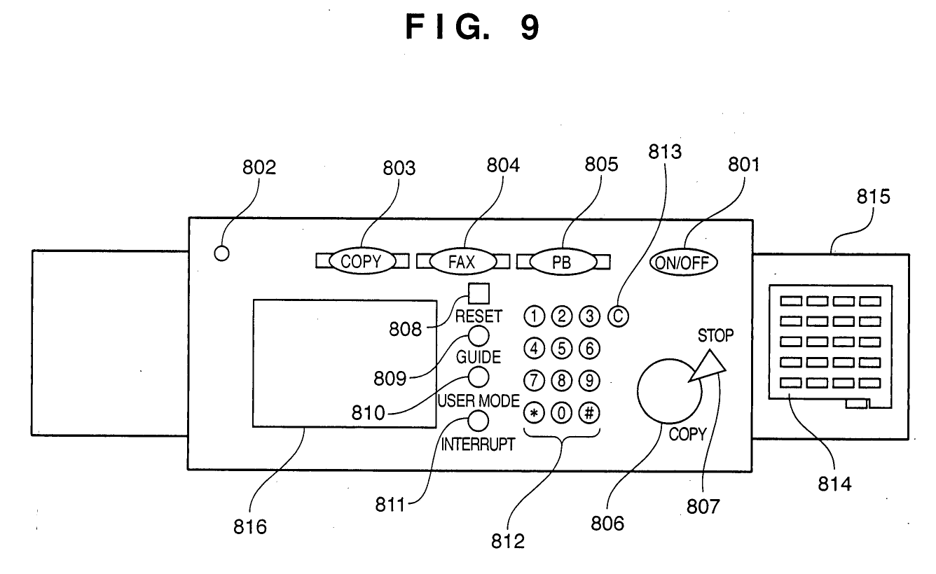

FIG. 9 shows an example of the outer appearance of the control panel 9. The control panel 9 comprises a power key 801, preheat key 802, copy function selection key 803, facsimile function selection key 804, personal box function selection key 805, start key 806, stop key 807, reset key 808, operation guide key 809, user mode setting key 810, interrupt copy key 811, ten-key pad 812, clear key 813, facsimile one-touch keys 814, one-touch key switching tab 815, touch panel 816, and the like.

The setting contents for the copy operations include the number of copy sets, print sheet size, enlargement/reduction ratio, one/two-sided copy, sorting mode, and the like, and can be input using the ten-key pad 812 and in accordance with setting items displayed on the touch panel 816. Assume that the following copy operation is set in this case.

C1: number of copy sets=10

C2: one-sided copy=yes

C3: print sheet size=A4

C4: enlargement/reduction ratio=100%

C5: layout=OFF

C6: sorting=ON

After the settings of the copy operation, the user sets documents on the reader 1 and presses the start key 806. The control panel 9 then transmits the copy setting parameters C1 to C6 to the CPU 123 of the core unit 10, thus issuing a processing request of the copy job.

Upon reception of the processing request (S601), the CPU 123 (session control task) divides the processing request of one unit into an image input job and image output job, generates a session (copy session 502 in this example) corresponding to these jobs (S602), and manages the session using the session management table 700 shown in FIG. 8. A description of various kinds of information held by the session management table 700 will be omitted. In this case, information indicating the copy session 502 is held in a session type field 702.

Next, the CPU 123 (session control task) generates a job management table 710 for the image input job 411 shown in FIG. 8 on the memory 124 (S603). The job management table 710 holds various kinds of information until the image input job 411 is completed. A description of various kinds of information held by this job management table 710 will be omitted. In this case, the job type field 712 holds information indicating the image input job 411, and the job parameter field 717 holds the copy setting parameters C1 to C6.

The CPU 123 (session control task) generates a job management table 730 for the image output job 401 shown in FIG. 8 on the memory 124 (S604). The job management table 730 holds various kinds of information until the image output job 401 is completed. A description of various kinds of information held by this job management table 730 will be omitted. In this case, the job parameter field 737 holds the copy setting parameters C1 to C6.

After the job management tables 710 and 730 are generated, the CPU 123 (session control task) launches the control tasks of the image input job and image output job to instruct to start the image input job 411 and image output job 401 (S605).

Upon reception of a job completion message from the image input job control task (S606), the CPU 123 (session control task) executes a completion process of the image input job 411, and sets a completion state in the job status field 714 of the job management table 710 (S607).

Upon reception of a job completion message from the image output job control task (S608), the CPU 123 (session control task) executes a completion process of the image input job 401, and sets a completion state in the job status field 734 of the job management table 730 (S609). Next, the CPU 123 (session control task) executes a completion process of the session, releases memory resources by discarding the job management tables 710 and 730 and image data of respective pages managed by the page management tables 720 and 740, and also discards the session management table 700, thus ending a series of processes (S610).

If the reader 1 is not busy, and a new read operation can be executed, the image input job control task starts the image input job 411 designated by the session control task.

The image input job control task receives image data for one page read by the reader 1 (S621). That is, image data for one page is transferred from the reader 1 to the data processor 121 via the I/F 120. Next, the image input job control task stores the image data input to the data processor 121 in the page memory 125 (S622), and transmits a page output request to the image output job control task (S623).

Upon completion of the read process of the image data of the page of interest from the page memory 125 by a process of the image output job control task to be described later, the image input job control task controls the storage unit 5 to store the image data stored in the page memory 125 in the hard disk 6 (S624). In this case, the image input job control task records various kinds of image attribute information (resolution, the number of pixels, and the like) in the page field 721 of the page management table 720.

Next, the image input job control task refers to a signal from the reader 1 to check if image data of all pages are stored in the hard disk 6 (S625). If pages to be stored still remains, the flow returns to step S621.

When image data of all documents are stored in the hard disk 6, the image input job control task transmits a job completion message to the session control task (S626), thus ending the control.

Since the image output job control task is the same as that of the aforementioned PDL print session 501, a description thereof will be omitted.

In the above examples, the processes of the controller 3 in the PDL print session 501 and copy session 502 have been explained. However, as shown in the session expansion examples of FIG. 6, even when an arbitrary session is formed by combining an arbitrary image input job and arbitrary image output job, the aforementioned control sequence can be similarly applied to that session.

[Hard Disk Management]

Next, confirmation of a free space and assurance of a use area on the hard disk 6 upon storing image data on the hard disk 6 of the storage unit 5 will be described below.

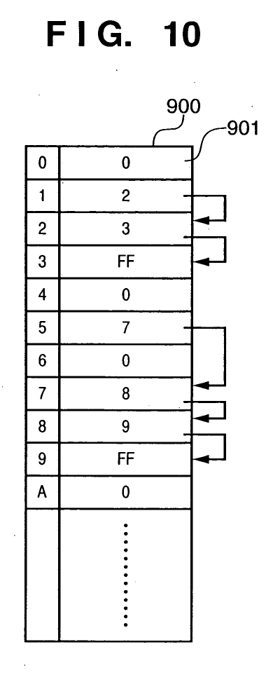

In general, a table called a File Allocation Table (FAT) is used to assure a disk area and to manage a use area. FIG. 10 shows a FAT 900 prepared in the storage unit 5 or core unit 10. The FAT 900 has a plurality of FAT entries 901. Each FAT entry 901 corresponds to a predetermined logical block. For example, if the logical block size of one FAT is 512 bytes, the total disk size is the number of FAT entries×512 bytes.

A use state of the FAT entry of interest and link are written in each FAT entry 901. “0” indicates an unused FAT entry, and a value other than “0” is written in a FAT entry in use. When a plurality of FAT entries are to be used, the number of an FAT entry to which the FAT entry of interest links is written, and “0xFF” is written in the FAT entry at the end of the link.

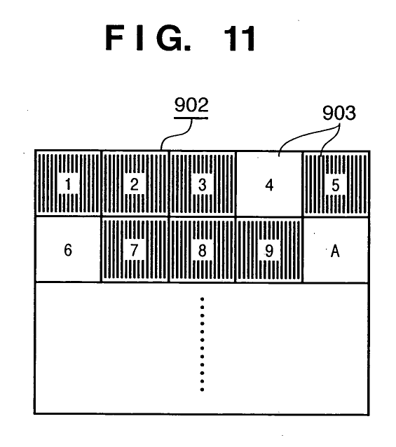

FIG. 11 conceptually shows the use state of the hard disk 6 managed by the FAT 900. A storage area 902 of the hard disk 6 includes a set of a plurality of logical blocks 903, and patterned logical blocks 903 indicate a storage area in use.

Therefore, the CPU 123 of the core unit 10 can recognize the use state (free state) of the hard disk 6 with reference to the FAT 900. That is, when the CPU 123 controls the storage unit 5 to store image data in the hard disk 6, it detects the free space of the hard disk 6, and can assure that area.

[Control in Disk Full State]

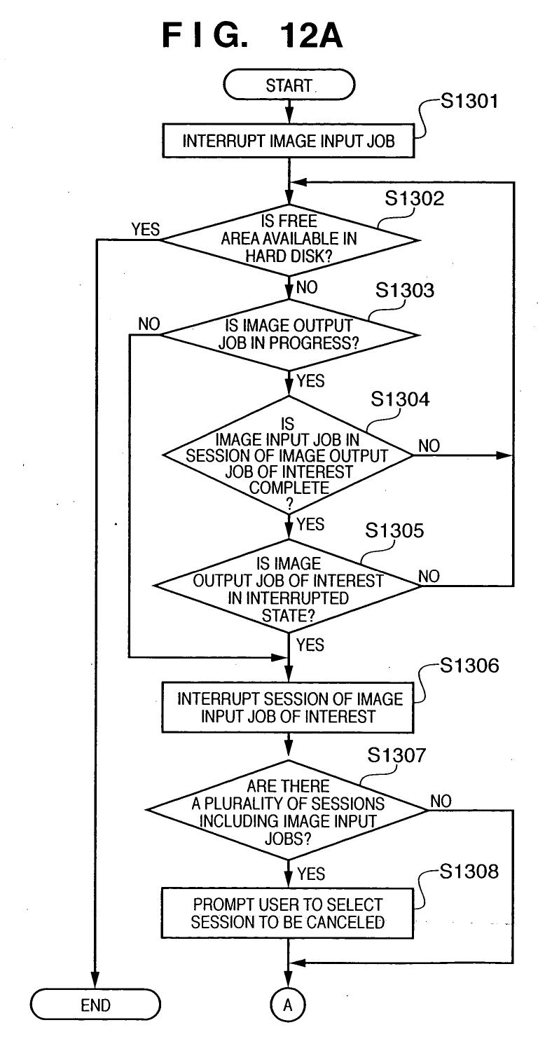

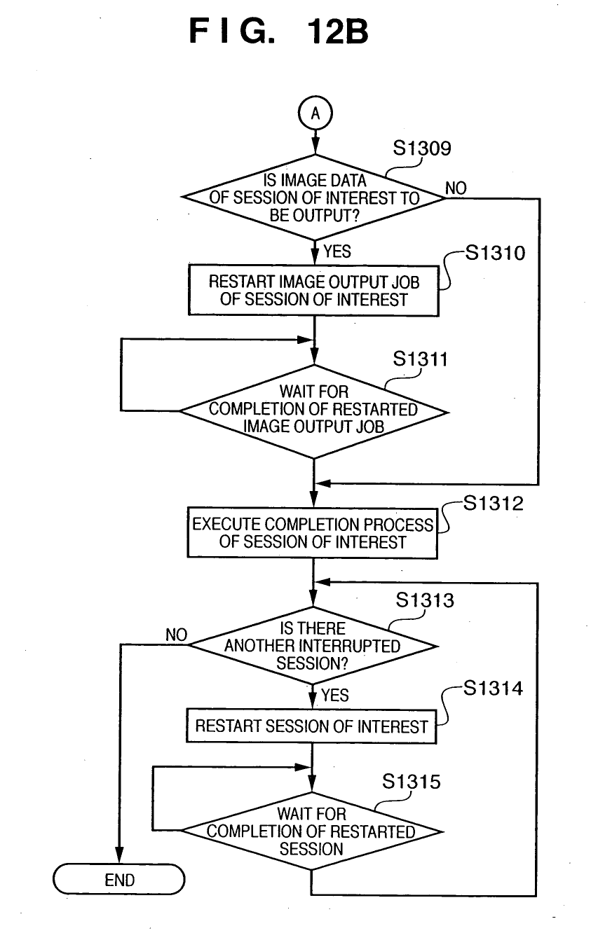

FIGS. 12A and 12B are flowcharts showing the control sequence executed by the CPU 123 when no storage area can be assured, i.e., in a disk full state upon storing image data in the hard disk 6 in step S624 in FIG. 7B. In the following description, assume that an image input job in execution is a job which inputs image data for a plurality of pages, and performs a print process of a plurality of copy sets, and that job encounters the disk full state after image data for at least one page is stored in the hard disk 6.

If the CPU 123 (image input job control task) detects a disk full state before or during storage of image data, it interrupts the current image input job (S1301), checks if the hard disk 6 has a free area (S1302), and ends the disk full state control if it detects the free area, thus returning to the normal control.

On the other hand, if it is determined that the hard disk 6 has no free area, the CPU 123 checks if an image output job currently in progress is found (S1303). If no image output job currently in progress is found, the flow jumps to step S1306. On the other hand, if an image output job currently in progress is found, the CPU 123 checks if the image input job in the session of the image output job of interest is complete (S1304). If the image input job is not complete yet, the flow returns to step S1302, and the CPU 123 waits for formation of a free storage area as a result of progress of the session.

On the other hand, if the image input job is complete, the CPU 123 checks if the image output job is set in an interrupted state due to some kind or another cause (S1305). The image output job in an interrupted state includes an image output job which interrupts output processes since print sheets are used up during printing, an image output job which interrupts output processes since printing cannot be continued due to factors such as paper jam, out-of-toner, and the like. In case of such image output job, when the interrupt factor is removed, the image output job is restarted, and the free area of the hard disk 6 may increase. Hence, if the image output job is in an output interrupted state due to some kind or another factor that can be removed, the CPU 123 waits for restart of the image output job by looping the processes in steps S1302 to S1305. If a free area can be formed on the hard disk 6 due to restart of the image output job, the CPU 123 restarts the image input job.

If no image output job in an interrupted state is found, the flow advances to step S1306. That is, the processing sequence in step S1306 and subsequent steps is executed by the CPU 123 (image input job control task) when it is determined that there is no chance to assure any storage area on the hard disk 6.

The CPU 123 (image input job control task) checks the session management table 700 to specify the session including the image input job of interest, and interrupts that session. In addition, the CPU 123 writes an interrupted state in a session status field 704 of the session of interest, and the job status field 714 of the job management table 710 of the image input job of interest (S1306).

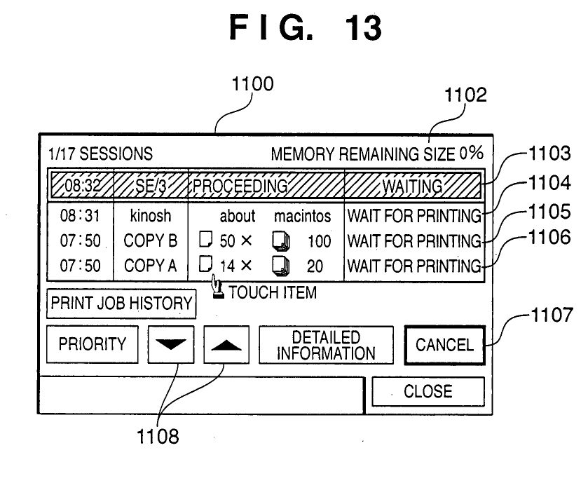

The CPU 123 checks if there are a plurality of sessions including image input jobs (S1307). If there are a plurality of sessions, the CPU 123 prompts the user to select a session to be canceled from these sessions (S1308). For the purpose of this selection, a selection dialog 1100 shown in FIG. 13 is displayed on the touch panel 816 of the control panel 9. A remaining size display field 1102 on the selection dialog 1100 indicates a free size of the hard disk 6, and displays “0%” in the example of FIG. 13. Session display fields 1103, 1104, 1105, and 1106 indicate a plurality of existing sessions. In the example of FIG. 13, sessions in the fields 1103 and 1104 are PDL print sessions 501, and those in the fields 1105 and 1106 are copy sessions 502. When the user selects one of the displayed sessions by operating selection keys 1108, and presses a cancel key 1107, the selected session is canceled.

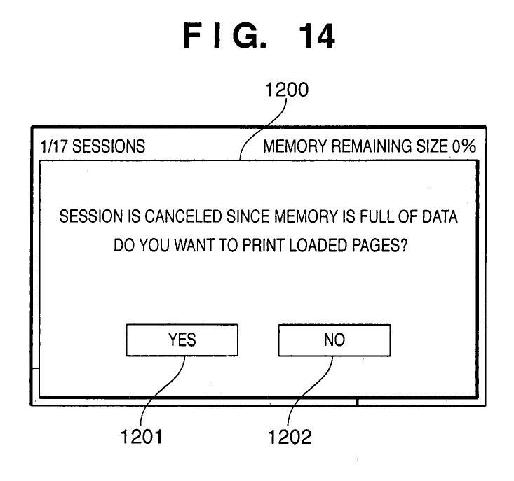

Next, the CPU 123 prompts the user to select whether or not image data stored in the hard disk 6 until the disk full state is reached for the session to be canceled (if only one session exists, that session; if there are a plurality of existing sessions, a session which is designated to be canceled) (S1309). For the purpose of this selection, a selection dialog 1200 shown in FIG. 14 is displayed on the touch panel 816 of the control panel 9. A “YES” key 1201 on the selection dialog 1200 corresponds to an output instruction of the image data; a “NO” key 1202 corresponds to a non-output instruction of the image data.

If the user presses the “YES” key 1201 on the selection dialog 1200, the CPU 123 executes a completion process of the image input job of the selected session which is designated to be canceled, restarts the image output job of the session of interest to output image data stored in the hard disk 6 (S1310), and waits for completion of the restarted image output job (S1311). If the restarted image output job is complete, a completion process of the session of interest is executed (S1312). If the user presses the “NO” key 1202 on the selection dialog 1200, the CPU 123 executes a completion process of the selected session which is designated to be canceled (including those of the image input job and image output job) (S1312). As a result of the cancel process of the session, a free area is generated on the hard disk 6.

Next, the CPU 123 checks with reference to the session management table 700 if another session interrupted due to occurrence of the disk full state exists (S1313). If such session exists, the CPU 123 restarts the interrupted session (S1314). In this stage, since the free area is generated on the hard disk 6 as a result of the session cancel process, the image input job of the restarted session can store image data using this free area. Subsequently, the CPU 123 waits for completion of the restarted session (51315). Upon completion of the session, the flow returns to step S1313, and the CPU 123 repeats the processes in steps S1313 to S1315 until all the interrupted sessions are completed. If all the interrupted sessions are complete, the CPU 123 ends the disk full state control, and returns to the normal control.

The above description has been given under the assumption that image data for at least one page is recorded in the hard disk 6 at the time of occurrence of a disk full state. However, when a disk full state has occurred without recording any image data even for one page, or when there is no point in image output using image data recorded halfway (e.g., when the print output process starts after all pages are temporarily recorded in the hard disk 6 in a specific print setting that records a plurality of images on a single print sheet like in a booklet mode, and so forth), the flow may jump from the user's output selection operation in step S1309 to step S1312 while skipping steps S1310 and S1311, and the completion process of the session may be immediately executed.

A disk full state may be determined while leaving a slight margin in place of a case wherein no recordable area remains in the hard disk 6. As a result, image input/output sessions of image data with a small data size can be efficiently executed in preference to those of image data with a large data size, and the device halt time can be shortened.

In the above description, a case has been exemplified wherein the input/output operations of image data are executed using the hard disk 6 of the storage unit 5. However, for example, when the page memory 125 of the data processor 121 is used without using the hard disk 6, and a memory full state occurs in the page memory 125, the same processing as in the above description can be applied.

[Data Structure of Job]

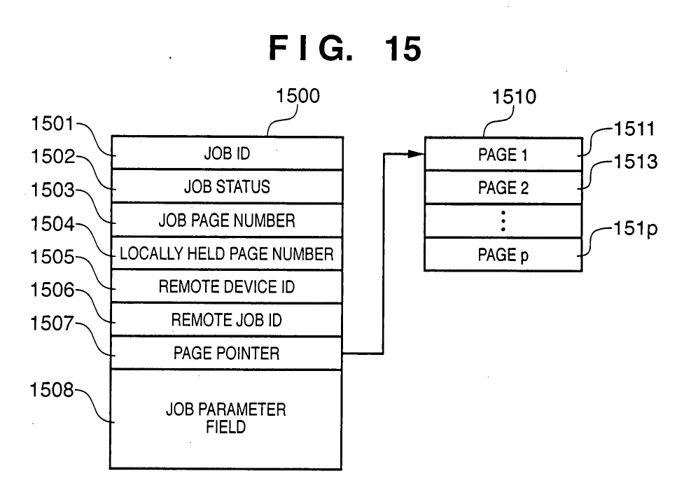

FIG. 15 shows an example of the structure of data of a print job stored in the hard disk 6.

A job ID field 1501 of a job management data area 1500 holds a unique job ID in that device. Note that the job ID is a unique ID in the device, but is not standardized among a plurality of devices.

A job status field 1502 holds information corresponding to an execution state (execution ready state, execution state, interrupted state, completion state, error state, or the like) of the job. A job page number field 1503 holds the number of pages of the job.

A locally held page number field 1504 holds the number of locally held pages. If the device of interest holds a data entity of the whole job, the value held in the locally held page number field 1504 becomes equal to that held by job page number field 1503.

A remote device ID field 1505 holds a device ID of a remote device when the device of interest holds data for a first few pages of that job, and that remote device holds data for the remaining pages. If the device of interest holds a data entity of the whole job, the remote device ID field 1505 holds “00”.

A remote job ID field 1506 holds a job ID of a remote device when the device of interest holds data for a first few pages of that job, and that remote device holds data for the remaining pages. If the device of interest holds a data entity of the whole job, the remote job ID field 1506 holds “00”.

A page pointer field 1507 holds a pointer to first page data of a page data area 1510 that holds data of that job. A job parameter field 1508 holds various setting parameters of that job, i.e., parameters associated with the number of copy sets, print sheet size, and the like.

In the example of FIG. 15, the page data area 1510 holds image data 1511 to 151p for the first to p-th pages. In this case, the locally held page number field 1504 holds the number “p” of pages.

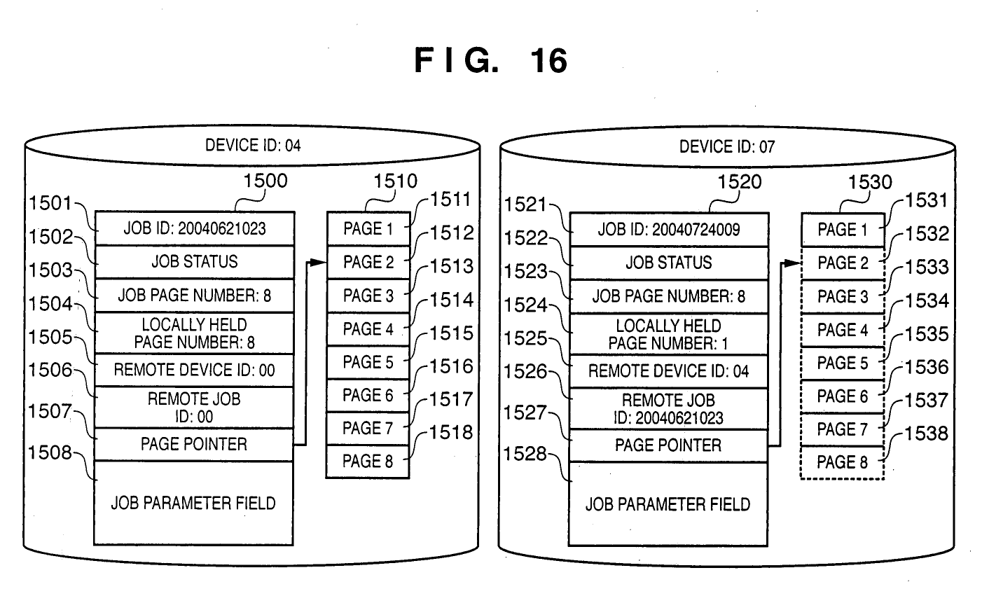

FIG. 16 shows an example of the data structure when distributed storage by partial redundant holding is applied.

As shown on the left side of FIG. 16, a device with device ID “04” holds full data of a job with job ID “20040621023”. A value “8” held in the job page number field 1503 indicates a print job including eight pages, and a value “8” held in the locally held page number field 1504 indicates that the local device (ID “04”) holds full data of the print job. Therefore, the remote device ID field 1505 and remote job ID field 1506 hold “00”. The page data area 1510 holds full data for eight pages of the print job.

The right side of FIG. 16 shows the data structure when a device with device ID “07” redundantly holds some data of a print job held by the device with device ID “04”.

The device with device ID “07” holds a job with job ID “20040724009”. A value “8” held in a job page number field 1523 indicates a print job including eight pages, and a value “1” held in the locally held page number field 1524 indicates that the local device (ID “07”) holds data for only the first page in place of full data of the print job. Therefore, a remote device ID field 1525 holds ID “04” of the device that holds the full data of the print job, and a remote job ID field 1526 holds job ID “20040621023” on the device with the device ID “04”. A page data field 1530 holds only data for the first page of those for eight pages.

FIG. 16 shows an example in which data for one page is redundantly held. Of course, data to be redundantly held is not limited to one page. The size (the number of pages) of data to be redundantly held may be changed depending on the print speed, the image processing speed, the length of a paper feed path, and the like of a device. In this way, efficient redundant holding according to the performance of a device can be done so as to implement continuos printing.

Whether or not redundant holding is executed or the data size (the number of pages) of data to be redundantly held may be selected depending on the data size or date of a job or the free space of the hard disk. As a result, more efficient, effective redundant holding can be made.

Furthermore, an attribute indicating a security level of a job may be assured, and a job with a high security level may be inhibited from being redundantly held, thus realizing a system that can assure security.

Using such data structure, as shown in FIG. 1, a job group 27 held by that device, and a job group 28 that redundantly holds data for a first part of a job stored in another device can be held by each device. Therefore, each of the MFPs 21 to 24, which are interconnected via the network 25, as shown in FIG. 1, allows the user to print or preview at least the first page within a short period of time using the data held by that device. In print or preview process of the subsequent pages, even when another device holds a data entity, since data for second page during the process of the first page, i.e., data of the following (N+1)-th page during the process of the N-th page can be transferred, and the aforementioned problem (the start of the print process and preview process take time) can be solved.

[Print Operation]

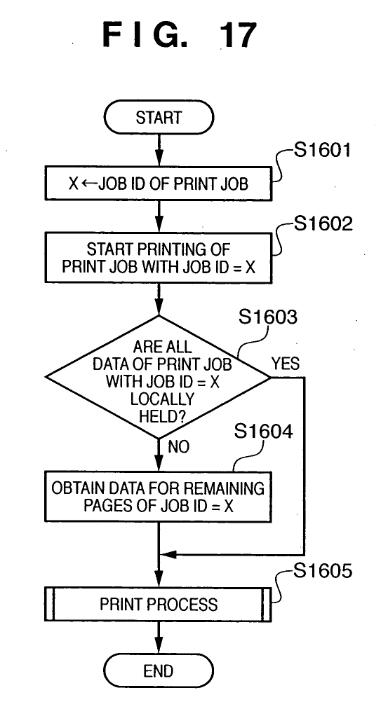

FIG. 17 is a flowchart showing the processing upon execution of a print job, i.e., the processing of the CPU 123 of the core unit 10.

If the user designates a print job at the control panel 9, the CPU 123 inputs a job ID of the print job to a variable X (S1601), and starts the print job with job ID=X (S1602). In this case, since at least data for the first page is locally held, it can be printed within a short period of time.

The CPU 123 checks if data for all pages of the print job with job ID=X are locally held (S1603). This checking process can be done by checking if the value in the locally held page number field 1504 is equal to that in the job page number field 1503.

If data for all pages of the print job with job ID=X are locally held, the print process (S1605) is continued; otherwise, the CPU 123 sends a request of data for the remaining pages of the print job with job ID=X to another MFP on the basis of the values in the remote device ID field 1505 and remote job ID field 1506 to obtain data for the remaining pages (S1604), and executes the print process (S1605). Note that data to be obtained from the other MFP can be data for the (p+1)-th page and subsequent pages if the value of the locally held page number field 1504 is p. However, if the value of the locally held page number field 1504 is “1”, data for all the pages may be obtained.

For example, if devices are interconnected by FTP (File Transfer Protocol), and a folder name in case of FTP access is used as a job ID, data of another device can be easily obtained. Note that the data obtaining method is not particularly limited, and file sharing, a dedicated protocol, and the like may be used.

Since data for a head page of a print job are locally held, the print process can be quickly started, and data for the remaining pages are obtained from another device and are continuously printed while the data for the first part is printed. Hence, the print process can be done as if all data were locally stored.

Other Embodiment

The present invention can be applied to a system constituted by a plurality of devices (e.g., host computer, interface, reader, printer) or to an apparatus comprising a single device (e.g., copying machine, facsimile machine).

Further, the object of the present invention can also be achieved by providing a storage medium storing program codes for performing the aforesaid processes to a computer system or apparatus (e.g., a personal computer), reading the program codes, by a CPU or MPU of the computer system or apparatus, from the storage medium, then executing the program.

In this case, the program codes read from the storage medium realize the functions according to the embodiments, and the storage medium storing the program codes constitutes the invention.

Further, the storage medium, such as a floppy disk, a hard disk, an optical disk, a magneto-optical disk, CD-ROM, CD-R, a magnetic tape, a non-volatile type memory card, and ROM can be used for providing the program codes.

Furthermore, besides aforesaid functions according to the above embodiments are realized by executing the program codes which are read by a computer, the present invention includes a case where an OS (operating system) or the like working on the computer performs a part or entire processes in accordance with designations of the program codes and realizes functions according to the above embodiments.

Furthermore, the present invention also includes a case where, after the program codes read from the storage medium are written in a function expansion card which is inserted into the computer or in a memory provided in a function expansion unit which is connected to the computer, CPU or the like contained in the function expansion card or unit performs a part or entire process in accordance with designations of the program codes and realizes functions of the above embodiments.

In a case where the present invention is applied to the aforesaid storage medium, the storage medium stores program codes corresponding to the flowcharts described in the embodiments.

As many apparently widely different embodiments of the present invention can be made without departing from the spirit and scope thereof, it is to be understood that the invention is not limited to the specific embodiments thereof except as defined in the claims.

### CLAIM OF PRIORITY

This application claims priority from Japanese Patent Application No. 2004-231438 filed on Aug. 6, 2004, which is hereby incorporated by reference herein.

What is claimed is:

1. An image processing apparatus connected to a computer network, comprising:
a holder, arranged to hold data of a print job in a memory;
a processor, arranged to execute a print process or preview process on the basis of the print job; and
an obtainer, arranged to obtain, when partial data of the print job are held in the memory, remaining data from another image processing apparatus via the computer network, and supply the remaining data to said processor.

2. The apparatus according to claim 1, wherein said holder holds data for a first part of the print job held in the other image processing apparatus.

3. The apparatus according to claim 2, wherein the data for the first part corresponds to data for at least one page.

4. The apparatus according to claim 1, wherein said obtainer begins to obtain the remaining data while the print process or preview process of the partial data is executed.

5. The apparatus according to claim 1, wherein said holder holds full data or partial data of the print job in the memory in accordance with a data size of the print job.

6. The apparatus according to claim 1, wherein said holder holds full data or partial data of the print job in the memory in accordance with the number of pages of the print job.

7. The apparatus according to claim 1, wherein said holder holds full data or partial data of the print job in the memory in accordance with performance of a print section.

8. The apparatus according to claim 7, wherein the performance of the print section includes a print speed.

9. The apparatus according to claim 7, wherein the performance of the print section includes an image processing speed.

10. The apparatus according to claim 7, wherein the performance of the print section includes a length of a paper feed path.

11. The apparatus according to claim 1, wherein said holder holds full data or partial data of the print job in the memory in accordance with a free space of the memory.

12. The apparatus according to claim 1, wherein said holder holds full data or partial data of the print job in the memory in accordance with date information of the print job.

13. The apparatus according to claim 1, further comprising a provider, arranged to provide, when data of a print job are requested from another image processing apparatus via the computer network, the requested data of the print job to the other image processing apparatus.

14. The apparatus according to claim 1, wherein said holder holds full data or partial data of the print job in the memory in accordance with a security level of the print job.

15. The apparatus according to claim 14, wherein said holder holds full data of a print job with a high security level in the memory.

16. A method of controlling an image processing apparatus connected to a computer network, said method comprising the steps of:
holding data of a print job in a memory;
executing a print process or preview process on the basis of the print job; and
obtaining, when partial data of the print job are held in the memory, remaining data from another image processing apparatus via the computer network, and supplying the remaining data to the print process or preview process.

17. A computer program for a method of controlling an image processing apparatus connected to a computer network, said method comprising the steps of:
holding data of a print job in a memory;
executing a print process or preview process on the basis of the print job; and
obtaining, when partial data of the print job are held in the memory, remaining data from another image processing apparatus via the computer network, and supplying the remaining data to the print process or preview process.

18. A computer program product stored on a computer readable medium comprising program code for a method of controlling an image processing apparatus connected to a computer network, said method comprising the steps of:
holding data of a print job in a memory;
executing a print process or preview process on the basis of the print job; and
obtaining, when partial data of the print job are held in the memory, remaining data from another image processing apparatus via the computer network, and supplying the remaining data to the print process or preview process.
